(19) United States
(12) Patent Application Publication
(10) Pub. No.: US 2026/0085479 A1
(43) Pub. Date: Mar. 26, 2026

(54) RECONFIGURABLE ACOUSTIC METAMATERIALS, RECONFIGURABLE NOISE BARRIERS, AND METHODS OF TUNING NOISE BARRIERS

(71) Applicant: Purdue Research Foundation, West Lafayette, IN (US)

(72) Inventors: Pablo D. Zavattieri, West Lafayette, IN (US); Yu Wang, Lafayette, IN (US); Jan Olek, West Lafayette, IN (US); Jeffrey Paul Youngblood, Crawfordsville, IN (US); David Leonardo Cubillos Gamez, West Lafayette, IN (US)

(21) Appl. No.: 19/335,906

(22) Filed: Sep. 22, 2025

Related U.S. Application Data
(60) Provisional application No. 63/697,714, filed on Sep. 23, 2024.

(51) Int. Cl. E01F 8/00; G10K 11/16

(52) U.S. Cl. CPC E01F 8/0094; G10K 11/16

(57) ABSTRACT

Reconfigurable acoustic metamaterials, reconfigurable noise barriers, and methods of tuning noise barriers. A reconfigurable acoustic metamaterial for a noise barrier includes one or more phononic crystals formed with a two-dimensional phase-transforming cellular material. A reconfigurable noise barrier may be formed with the reconfigurable acoustic metamaterial. The phase-transforming cellular material allows the phononic crystals to be tuned by applying in-plane forces to either expand or collapse the two-dimensional phase-transforming cellular material two-dimensionally in the plane of the phase-transforming cellular material.

### CROSS-REFERENCE TO RELATED APPLICATIONS

This application claims the benefit of provisional U.S. Patent Application No. 63/697,714 filed Sep. 23, 2024, the contents of which are incorporated herein by reference.

### STATEMENT REGARDING FEDERALLY SPONSORED RESEARCH

This invention was made with government support under 69A3552348333 awarded by the Department of Transportation. The government has certain rights in the invention.

### BACKGROUND OF THE INVENTION

The invention relates generally to reconfigurable acoustic metamaterials, reconfigurable noise barriers, and methods of tuning noise barriers.

Noise is pervasive in various environments, originating from sources like rooms, industries, roadways, airports, and other forms of transportation. Traffic noise frequencies generated on roadways, including controlled-access highways (also referred to as freeways, motorways, and expressways) that pass through residential areas, fluctuate based on factors such as vehicle types, weather, road conditions, and traffic flow. These variations in traffic conditions can cause the dominant noise frequencies to shift between 500 and 1200 Hz. Traditionally, noise barriers have been erected alongside roadways to mitigate the effects of traffic noise to adjacent areas. Such traditional noise barriers were typically in the form of vertical walls, often made of concrete, brick, and/or wood.

Although they typically do reduce the traffic noise levels to adjacent areas, traditional noise barriers have several drawbacks. For example, conventional noise barriers are typically heavy and can impose significant loads and moments on their foundations. Furthermore, when oblique sound waves strike a conventional noise barrier, increased diffraction at the top edge of the barrier can allow more noise to propagate beyond the barrier. This diffraction reduces the effectiveness of the barrier across different frequencies. Conventional noise barriers also block airflow and light to adjacent areas, which can negatively impact nearby residents.

Sonic crystals (also referred to as phononic crystals) have been developed to overcome some of these limitations. Sonic crystals are artificial structures having a periodic arrangement of acoustic scattering structures (e.g., sound-attenuating structures) having a high acoustic impedance. When used as noise barriers on a large scale, sonic crystals are typically non-homogeneous structures created by the arrangement of scatterers in a periodic configuration with a square, rectangular, or triangular pattern. The scatterers are typically elongate structures, such as steel sheets, cylinders, or spheres. The scatterers are often made of a material with high acoustic impedance with respect to the medium in which they are positioned, such as acrylic cylinders in air. The periodic arrangement of the sound scatterers causes the sonic crystals to have selective sound attenuation properties in a specific range of frequencies, known as the band gap, due to destructive interference of the sound waves caused by the scatterers. The frequencies attenuated by the band gap can be tuned by adjusting the periodic configuration of the scatterers. Additional details regarding known sonic crystals may be found, for example, in Fredianelli, Recent Developments in Sonic Crystals as Barriers for Road Traffic Noise Mitigation, Environments 6(2):14 (2019) (available at DOI:10.3390/environments6020014), the contents of which are incorporated herein by reference.

A particular type of traffic noise barrier utilizing sonic crystals is disclosed in Thota et al., Reconfigurable Origami Sonic Barriers with Tunable Bandgaps for Traffic Noise Mitigation, Journal of Applied Physics, 122(15), the contents of which are incorporated herein by reference. As shown in FIGS. 1A to 1C, such a noise barrier is an origami-based design (referred to as an origami sonic barrier, or OSB) that mitigates traffic noise with different frequencies. The noise barrier is made of a lattice of vertically oriented cylindrical inclusions (e.g., cylindrical pipes) attached to an origami base made of several sections that can be angularly adjusted (“folded”) relative to each other. The origami base can be reconfigured between a flat configuration and a plurality of folded configurations, which shift the spatial relationships between the cylindrical inclusions. This allows the noise barrier to adjust its sound-blocking properties by transforming the periodicity of the cylindrical inclusions between different square and hexagonal lattices by folding the base.

FIGS. 1A through 1C show the origami sonic barrier in various folding configurations, along with their corresponding cross-sectional views. Polygons shown in the cross-sectional views highlight the transformation of the lattice pattern from a hexagonal lattice at a 0-degree folding angle shown in FIG. 1A, to a square lattice at a 55-degree folding angle shown in FIG. 1B, and then to a denser hexagonal lattice at a 70-degree folding angle shown in FIG. 1C. This reconfiguration enables significant tuning of acoustic dispersion characteristics of the sonic barrier. Studies demonstrate that this reconfigurable sonic barrier can be optimized for specific traffic noise frequencies. For example, a 55-degree folding angle between adjacent base sections forming a square lattice configuration effectively mitigates low-frequency noise around 500 Hz, while a 70-degree folding angle between adjacent base sections forming a hexagonal lattice configuration is effective for higher frequencies around 1000 Hz. However, a noise barrier design such as shown in FIGS. 1A through 1C can be complex and costly to manufacture, install, and/or operate.

Therefore, it would be desirable to develop noise barriers that can address one or more of the limitations identified above and effectively attenuate the constantly shifting dominant frequencies of traffic noise, thereby reducing the harmful effects of noise pollution.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, reconfigurable acoustic metamaterials, reconfigurable noise barriers, and methods of tuning noise barriers.

According to a nonlimiting aspect, a reconfigurable acoustic metamaterial for a noise barrier includes one or more phononic crystals formed with a two-dimensional phase-transforming cellular material.

According to another nonlimiting aspect, a reconfigurable noise barrier includes a base formed of a two-dimensional phase-transforming cellular material, and a plurality of sound-attenuating structures extending from one side of the base. Phase transformation of the phase-transforming cellular material in a first in-plane direction shifts the sound-attenuating structures from an expanded configuration to a contracted configuration. Phase transformation of the phase-transforming cellular material in a second in-plane direction shifts the sound-attenuating structures from the contracted configuration to the expanded configuration.

According to still another nonlimiting aspect, a method of using the reconfigurable noise barrier as described above is provided. The method includes contracting the two-dimensional phase-transforming cellular material of the base in plane with first in-plane forces to shift the sound-attenuating structures closer together toward the contracted configuration thereof, and expanding the two-dimensional phase-transforming cellular material of the base in plane with second in-plane forces opposite the first in-plane forces to shift the sound-attenuating structures further apart toward the contracted configuration thereof.

Technical aspects of reconfigurable acoustic metamaterials, reconfigurable noise barriers, and/or methods as described above preferably include the ability to offer dynamic adaptation and control over noise mitigation and/or provide enhanced noise reduction performance and flexibility in a lightweight, aesthetic design.

These and other aspects, arrangements, features, and/or technical effects will become apparent upon detailed inspection of the figures and the following description.

### BRIEF DESCRIPTION OF THE DRAWINGS

FIGS. 1A-1C illustrate a known reconfigurable sonic barrier for reducing traffic noise. FIG. 1A is an isometric view of the reconfigurable sonic barrier in a flat configuration. FIG. 1B is an isometric view of the reconfigurable sonic barrier in a folded configuration of 55°. FIG. 1C is an isometric view of the reconfigurable sonic barrier in a folded configuration of 70°.

FIG. 2 is a diagrammatic illustration of a reconfigurable tunable noise barrier constructed with phononic crystals according to a nonlimiting embodiment of the invention.

FIGS. 3 and 4 illustrate a reconfigurable phononic crystal of a tunable noise barrier in a first, expanded configuration, according to some nonlimiting aspects of the present invention. FIG. 3 is an isometric view of the phononic crystal and represents the phononic crystal as comprising sound-attenuating structures mounted on a two-dimensional phase-transforming cellular material that includes a base comprising multiple individual cell units that are arranged so that the two-dimensional phase-transforming cellular material has an expanded hexagonal configuration. FIG. 4 represents a top view (left side) and a diagrammatic illustration (right side) of the phononic crystal of FIG. 3.

FIGS. 5 and 6 illustrate the phononic crystal of FIGS. 3 and 4 as having acquired a second, more compact configuration as a result of flexing bistable leaf members of the cell units. FIG. 5 is an isometric view of the phononic crystal and represents the two-dimensional phase-transforming cellular material as having a more compact hexagonal configuration, and FIG. 6 represents a top view (left side) and a diagrammatic illustration (right side) of the phononic crystal of FIG. 5.

FIG. 7 schematically represents a process by which the cell units can be actuated by applying a force to individual bistable leaf members of the cell units so as to flex the leaf members between two stable and/or metastable configurations.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) to which the drawings relate. The following detailed description also identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to recite what are believed to be aspects of the invention, including certain but not necessarily all of the aspects and alternatives described in the detailed description.

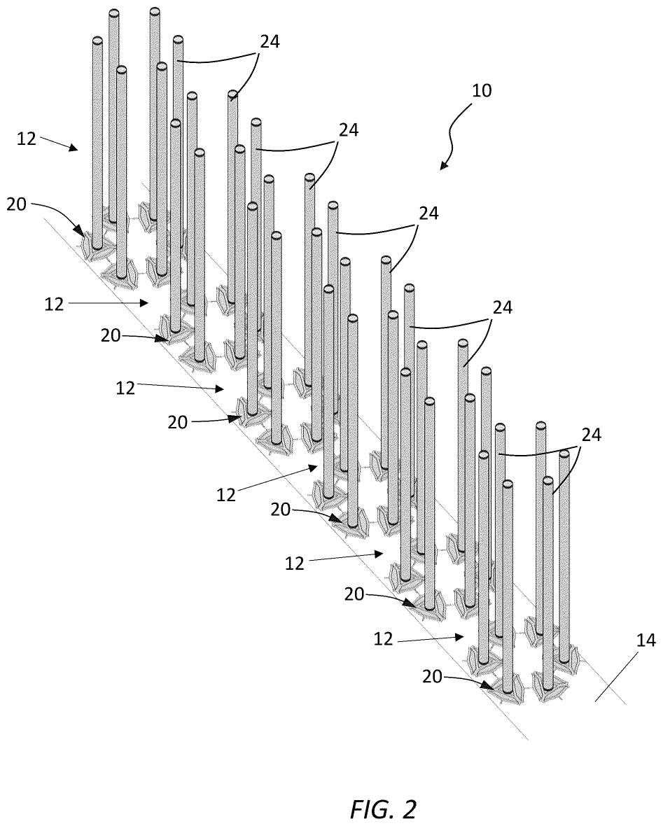

FIGS. 2 through 6 depict a lightweight reconfigurable tunable noise barrier 10 that can effectively mitigate traffic noise across different frequencies. The noise barrier 10 can generally be described as a phononic crystal noise barrier that includes phononic crystals 12 (also referred to as sonic crystals) arranged to form an elongate wall of adaptive acoustic metamaterial. Each phononic crystal 12 comprises multiple sound-attenuating structures 24 mounted on a two-dimensional phase-transforming cellular material (PXCM) that includes a base 20 having multiple individual cell units 22. As represented, the phononic crystals 12 and their bases 20 may be supported by or integrated onto a supporting foundation 14. Various phase transforming cellular materials suitable for forming the bases 20 are disclosed in Zhang et al., Energy Dissipation in Functionally Two-Dimensional Phase Transforming Cellular Materials, Scientific Reports, 9(1) 1-11 (2019) (DOI: 10.1038/s41598-019-48581-8), the contents of which are incorporated herein by reference. The noise barrier 10 provides tunable acoustic attenuation properties, making it suitable for reducing complex traffic noise patterns. By altering the configuration of their bases 20, the periodic arrangement of the phononic crystals 12 can be reconfigured. This change in configuration significantly modifies the acoustic properties of the noise barrier 10, allowing for precise control for noise mitigation in different frequencies. Additionally, the use of the phononic crystals 12 can create lightweight structures that allow both light and airflow to pass through the barrier 10.

To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of the reconfigurable noise barrier 10 during its use and/or as represented in the drawings. All such relative terms are useful to describe the illustrated embodiment(s) but should not be otherwise interpreted as limiting the scope of the invention.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

FIG. 2 represents the noise barrier 10 as incorporating six phononic crystals 12 arranged to form an elongate wall of adaptive acoustic metamaterial, and shows each phononic crystal 12 as comprising six sound-attenuating structures 24 mounted on its base 20. More particularly, each sound-attenuating structure 24 is shown as mounted on an individual cell unit 22, and in combination the cell units 22 form the base 20 of the phononic crystal 12 at least in part or, as represented, in its entirety. The number of phononic crystals 12, bases 20, cell units 22, and/or sound-attenuating structures 24 can be increased or decreased to comport to the needs of a particular application. The noise barrier 10 is particularly well suited for use as a sonic barrier to attenuate traffic noise from a roadway, including but not limited to controlled-access highways that pass through residential and other noise-sensitive areas. However, the noise barrier 10 may be used as a sonic barrier for other applications and/or in other types of locations, such as surrounding noisy equipment in a factory or other setting, at airports, along railroad tracks, or almost any other setting where relatively large-scale outdoor or indoor noise-attenuating barriers may be desired.

The noise barrier 10 is shown in FIG. 2 as incorporating six separate phononic crystals 12 aligned in a single row. However, fewer or more phononic crystals 12 may be provided in a row, and/or additional rows may be incorporated in parallel to the row shown, and/or the phononic crystals 12 may be arranged in other configurations suitable for forming a noise barrier.

In some configurations, the noise barrier 10 may be assembled as pre-fabricated panels or units that can be installed end-to-end as units along a roadway to form an elongate wall extending generally parallel to and adjacent the roadway. Precast concrete barriers may integrate one or more of the phononic crystals 12 as part of a traffic noise noise barrier. In addition, additional structures and/or materials may optionally be incorporated within and/or around the noise barrier 10, such as an additional foundation 14 and/or other supporting structure for supporting the noise barrier 10. By integrating phononic crystals 12 with bases 20 formed by phase-transforming cellular materials, the noise barrier 10 can be dynamically adapted to varying traffic noise frequencies, enhancing noise mitigation capabilities across a broad spectrum.

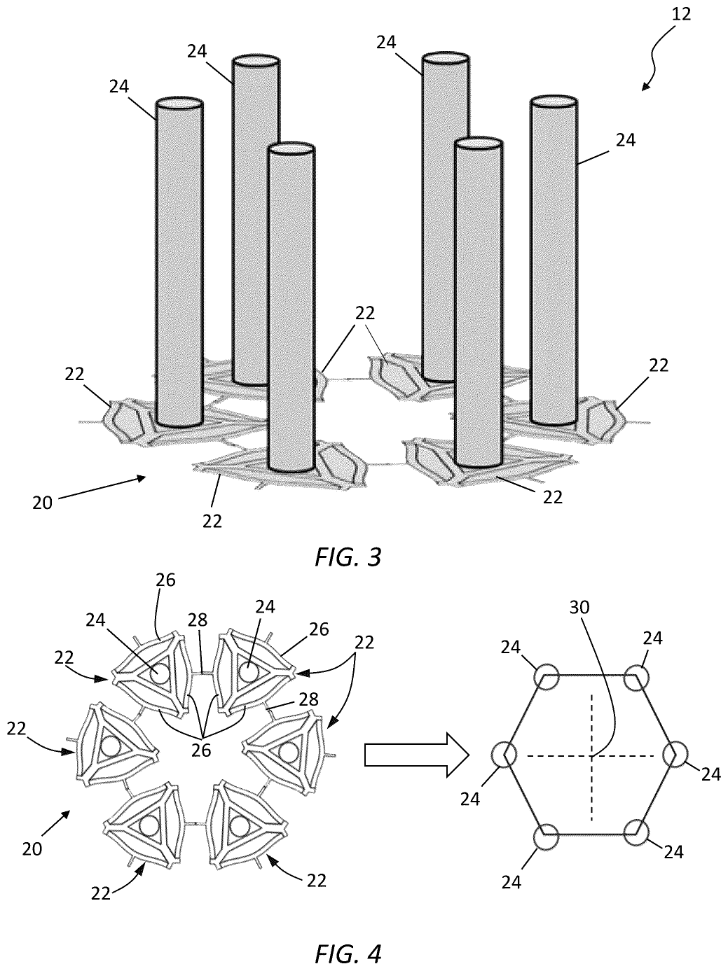

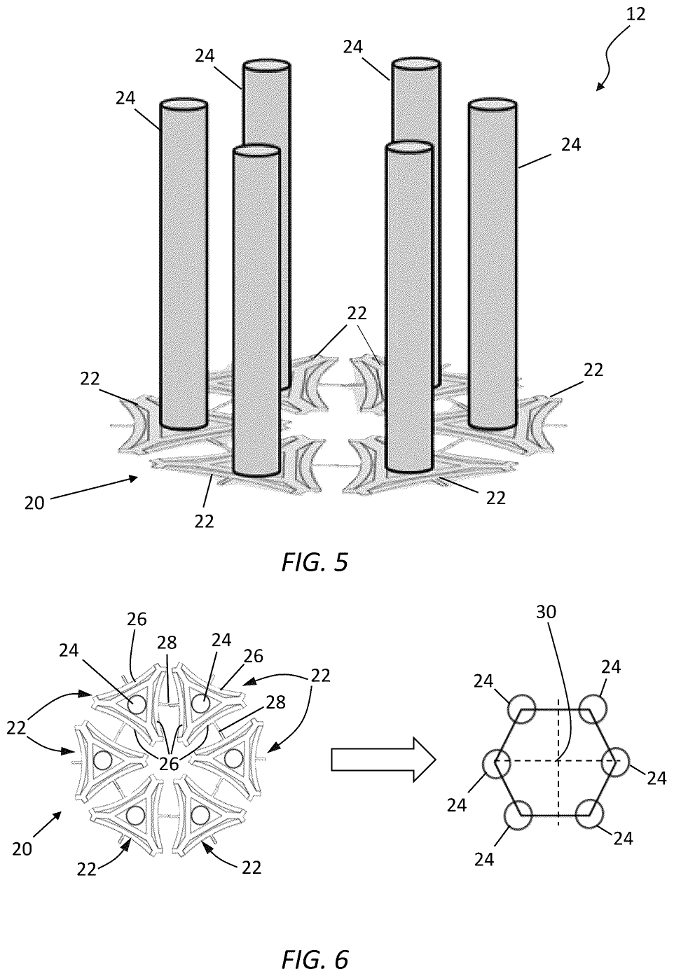

FIGS. 3 and 5 depict a single phononic crystal 12 and the sound-attenuating structures 24 thereof extending upwardly from its base 20, which in turn is formed by a plurality of unit cells 22. The configuration of the base 20 and its unit cells 22 constitute a two-dimensional phase-transforming cellular material, as will become apparent from the following discussion. The unit cells 22 are arranged in generally two-dimensional configurations having a top side and a bottom side, as seen in FIGS. 3 and 5. The phononic crystal 12 is represented as comprising six unit cells 22 arranged in a hexagon. A single sound-attenuating structure 24 extends upwardly from the top side of each unit cell 22 (as portrayed in the drawings). In this example, the sound-attenuating structures 24 are in the form of elongate rods formed of or coated with sound-attenuating material, though other types and shapes of sound-attenuating structures may be used.

The noise barrier 10 of FIG. 2 is referred to herein as “reconfigurable” because the shape of the noise barrier 10 can be repeatedly modified through the operation of the base 20 of any one or more phononic crystals 12 of the barrier 10 and the unit cells 22 of the bases(s) 20 of the one or more phononic crystals 12. In the example represented in FIGS. 3 through 6, the unit cells 22 are bistable structures that can be shifted between expanded and contracted configurations. In the embodiment shown, each unit cell 22 has a generally triangular shape with three outer bistable leaf members 26 forming the outer peripheral sides of the triangle. One bistable leaf member 26 of each unit cell 22 faces in a radially outward direction of the hexagonal shape of the base 20 (and therefore may be referred to as an exterior bistable leaf member 26), and the remaining two bistable leaf members 26 of each unit cell 22 face an immediately adjacent unit cell 22 (and may be referred to as interior bistable leaf members 26). A strut 28 connects an interior bistable leaf member 26 of one cell 22 with an interior bistable leaf member 26 of an adjacent cell 22. It should be understood that other shapes and types of PXCM bases and unit cells could be used.

The bistable leaf members 26 are each configured to flex between a first position, shown in FIGS. 3 and 4 as flexed outward away from the center 30 of its unit cell 22, and a second position, shown in FIGS. 5 and 6 as flexed inward toward the center 30 of its unit cell 22. When the bistable leaf members 26 are caused to be in their first positions as shown in FIG. 4, the unit cells 22 are shifted radially outward from the center 30 of the base 20 to enlarge the hexagonal configuration of the base 20 such that the sound-attenuating structures 24 are spaced apart from each other by a relatively greater distance, yielding an expanded configuration of the base 20. In contrast, when the bistable leaf members 26 are caused to be in their second positions shown in FIGS. 5 and 6, the unit cells 22 are shifted radially inward toward the center 30 of the base 20 to a more compact hexagonal configuration such that the sound-attenuating structures 24 are spaced apart from each other a lesser distance, yielding a contracted configuration of the base 20. Thus, the individual unit cells 22 and the base 20 as a whole may be referred to as bistable between two stable (or metastable) configurations, in which the sound-attenuating structures 24 are closer to each other in the stable (or metastable) contracted configuration shown in FIGS. 5 and 6 than in the stable (or metastable) expanded configuration shown in FIGS. 3 and 4. This reconfigurability enables the periodic structure of a phononic crystal 12, as well as a noise barrier 10 formed therewith, to adapt to varying traffic noise frequencies, which offers the capability of enhancing noise mitigation across a broad spectrum.

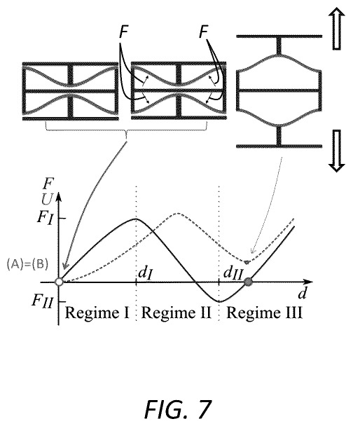

The functionality of a phase-transforming cellular material that constitutes the base 20 relies on its ability to undergo controlled bistable transformations. A challenge lies in actuating individual unit cells 22 efficiently to enable a desired cascade effect for expanding and contracting an individual phononic crystal 12 as well as a noise barrier 10 formed therewith. The base 20 may be shifted between its two configurations by various types of actuators, such as one or more hydraulic, pneumatic, and/or electric actuators. Generally, the actuator(s) are configured to contract and/or expand the base 20 with lateral (in-plane) forces acting on the bistable leaf members 26 to either collapse or expand the individual unit cells 22 relative to each other. For example, the sound-attenuating structures 24 of a phononic crystal 12 may be shifted closer together (into a denser configuration) by applying first in-plane forces to the bistable leaf members 26 that cause the base 20 to contract within the plane of the base 20, resulting in the contracted configuration depicted in FIGS. 5 and 6. Similarly, the sound-attenuating structures 24 may be shifted farther apart (into a more open configuration) by applying opposite second in-plane forces to the bistable leaf members 26 that cause the base 20 to expand within the plane of the base 20, resulting in the expanded configuration depicted in FIGS. 3 and 4. FIG. 7 presents an example on how in-plane forces (F) can be applied to individual leaf members 26 at the unit cell level to induce phase transformation between two stable (or metastable) states. In other words, the forces F (which can be actuated remotely) allow the configuration of one or more unit cells 22 or one or more bases 22 (and the sound-attenuating structures 24 and phononic crystal 12 associated therewith) to change from one stable (or metastable) configuration to another stable (or metastable) configuration.

As illustrated in FIGS. 3 through 6, using the base 20 as an actuator to change the lateral spacing between the sound-attenuating structures 24 allows the arrangement of phononic crystals 12 to be actively modified. The spacing between the unit cells 22 of these crystals 12 is an important factor that determines the specific frequencies at which noise is mitigated. Adjusting these distances can significantly adapt the spectral properties of the bandgaps, allowing the acoustic metamaterial to respond effectively to changes in noise frequency. Compact hexagonal configurations are particularly effective at mitigating high-frequency noise compared to more loosely arranged hexagonal patterns. Therefore, the use the reconfigurable acoustic metamaterials in the noise barrier 10 in circumstances where adaptive noise control is desired, such as in urban environments affected by fluctuating traffic noise levels, may be particularly advantageous.

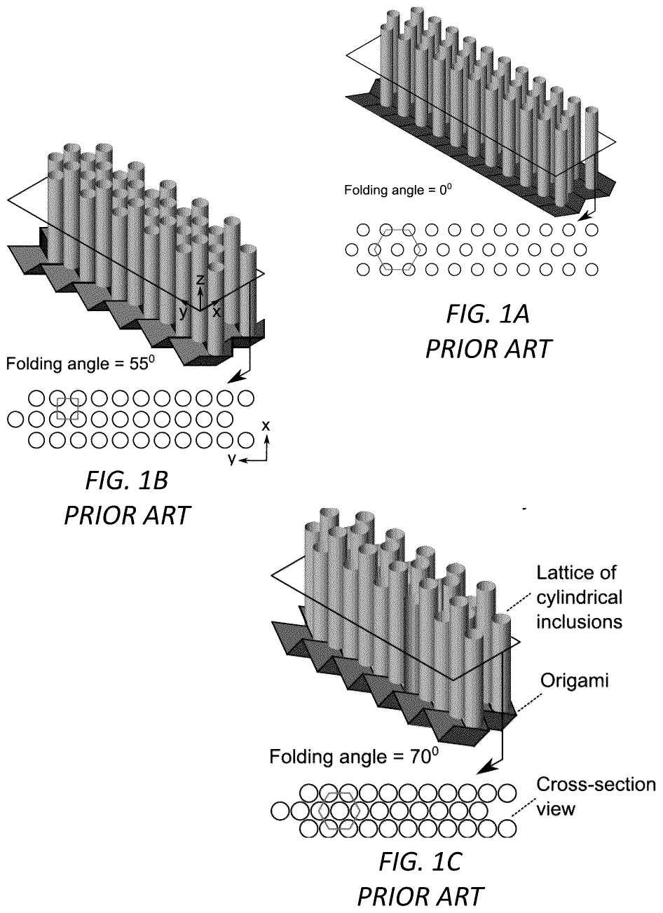

The shape-shifting noise barrier 10 addresses the problem of limited and non-adaptive noise absorption in conventional fixed-geometry noise barriers. By altering its shape, the barrier 10 changes the spacing between embedded phononic crystals 12, allowing the barrier 10 to target and absorb sound more effectively across a range of frequencies typically associated with traffic noise. Furthermore, unlike the sonic barrier in FIGS. 1A-1C, the movement of the base 20 between the expanded and contracted configurations of FIGS. 3 and 5 is substantially two-dimensional within the plane of the base 20. In contrast, the movement of the origami base in the sonic barrier of FIGS. 1A-1C requires individual base sections to shift up and down in a third dimension out of plane from the base as well as in-plane in order to shift the inclusions. Thus, the bases 20 shown in FIGS. 2 through 6 and the arrangement of their unit cells 22 provide for simpler actuation of the noise barrier 10 and its phononic crystals 12.

During investigations leading to the present invention, experimental tests were conducted with a 1:7 scaled model of a single phononic crystal was constructed to generally resemble that illustrated in FIGS. 3 through 6. The barrier model demonstrated substantial improvements in sound absorption when switching a phononic crystal as represented in FIGS. 2 through 6 between its expanded and contracted configurations. For example, at 6150 Hz, which corresponds to approximately 878.6 Hz at full scale, the absorption ratio of the barrier model increased dramatically from 0.282 in the expanded configuration to 0.914 in the contracted configuration. Similar enhancements were observed at other key frequencies: at 10257 Hz (scaled to 1465.3 Hz), the absorption ratio increased from 0.348 to 0.808, and at 3130 Hz (scaled to 447.1 Hz), the absorption ratio increased from 0.188 to 0.469. These results evidenced that a noise barrier equipped with reconfigurable bases 20 as described is capable of performing particularly well within the 350-1500 Hz range, which aligns with the dominant frequency band of roadway noise.

Additionally, the experimental barrier model evidenced its ability to influence system resonance behavior. In the absence of the barrier model, absorption peaks were observed at 4200 Hz and 9067 Hz. When the barrier model was introduced, the 4200 Hz peak showed an absorption increase of 10.61% in the expanded configuration and 26.83% in the contracted configuration. The 9067 Hz peak shifted to 9183.8 Hz and 9772 Hz in the expanded and contracted configurations respectively, indicating that the barrier model not only enhanced absorption but also altered the acoustic response of the system.

The investigation performed with the barrier model demonstrated that a noise barrier constructed of phononic crystals 12 in accordance with the foregoing can be effectively capable of adapting to different acoustic environments, significantly improving noise attenuation at targeted frequencies. Furthermore, the investigation showed that, if its base and phononic crystals are selectively expanded and contracted in real time in response to a changing acoustic spectrum detected within its operating environment, a noise barrier is able to overcome the static limitations of traditional noise barriers and render the noise barrier especially suitable for traffic-heavy environments where frequency content varies throughout the day.

In view of the above, a noise barrier configured as described above is capable of addressing various issues with conventional traffic noise barriers. Conventional barriers struggle with the varying frequencies of traffic noise, which can shift between 500 and 1200 Hz, and are often heavy, imposing significant loads on their foundations. Conventional barriers also tend to increase diffraction at their top edges when struck by oblique sound waves, allowing more noise to escape, and block light and airflow, negatively impacting nearby areas. In contrast, the noise barrier 10 made with reconfigurable acoustic metamaterials formed by lightweight phononic crystals 12 integrated with phase-transforming cellular materials (the bases 20 and their cell units 22) is able to overcome these drawbacks by offering dynamic adjustability to better manage fluctuating noise frequencies. In particular, the two-dimensional phase-transforming cellular material of a base 20 can be selectively contracted in plane with first in-plane forces to shift the sound-attenuating structures 24 closer together toward their contracted configuration, and the two-dimensional phase-transforming cellular material of the base 20 can also be selectively expanded in plane with second in-plane forces opposite the first in-plane forces to shift the sound-attenuating structures 24 further apart toward their contracted configuration. In so doing, the use of the phononic crystals 12 in a noise barrier is able to enhance adaptive noise control across a broad range of frequencies, while also allowing light and airflow to pass through, providing a more effective and environmentally friendly solution for mitigating traffic noise from roadways.

In view of the above, the phononic crystals 12 and noise barrier 10 may, in various embodiments, provide one or more advantages over conventional traffic noise barrier systems. For example, unlike traditional static barriers, which have a fixed configuration once installed, the phononic crystals 12 combined with their base 20 allow for dynamic reconfiguration. This enables the noise barrier 10 to adapt its acoustic properties in real-time to varying traffic noise frequencies, offering enhanced adaptability. In addition, the integration of bases 20 with phononic crystals 12 provides greater flexibility compared to static barriers. For example, by adjusting the configuration of a base 20, the periodic arrangement of the phononic crystals 12 can be modified to address different noise conditions more effectively. Furthermore, the bases 20 and phononic crystals 12 offer a lightweight alternative to conventional barriers, which can reduce structural load and simplify installation, while still providing effective noise mitigation. Furthermore, the combination of the bases 20 and phononic crystals 12 allows for improved light and airflow through the barrier 10, addressing issues associated with traditional barriers that often block these elements.

As previously noted above, though the foregoing detailed description describes certain aspects of one or more particular embodiments of the invention, alternatives could be adopted by one skilled in the art. For example, the reconfigurable noise barrier 10 and its components could differ in appearance and construction from the embodiments described herein and shown in the drawings, functions of certain components of the noise barrier 10 could be performed by components of different construction but capable of a similar (though not necessarily equivalent) function, and various materials could be used in the fabrication of the noise barrier 10 and/or its components. As such, and again as was previously noted, it should be understood that the invention is not necessarily limited to any particular embodiment described herein or illustrated in the drawings.

1. A reconfigurable acoustic metamaterial for a noise barrier, the reconfigurable acoustic metamaterial comprising:
one or more phononic crystals comprising a two-dimensional phase-transforming cellular material.

2. The reconfigurable acoustic metamaterial of claim 1, wherein, the phononic crystal comprises the phase-transforming cellular material and a plurality of sound-attenuating structures carried by the phase-transforming cellular material.

3. The reconfigurable acoustic metamaterial of claim 2, wherein the phase-transforming cellular material is formed of a two-dimensional arrangement of phase-transforming cellular material unit cells.

4. The reconfigurable acoustic metamaterial of claim 3, wherein and at least one of the sound-attenuating structures is carried by each of the phase-transforming cellular material unit cells such that phase-shifting the phase-transforming cellular material in a first direction enlarges spacing between the sound-attenuating structures, and phase-shifting the phase-transforming cellular material in a second direction reduces spacing between the sound-attenuating structures.

5. The reconfigurable acoustic metamaterial of claim 4, wherein the phase-transforming cellular material unit cells are arranged in a hexagon with one of the sound-attenuating structures disposed at each corner of the hexagon.

6. The reconfigurable acoustic metamaterial of claim 5, wherein each of the phase-transforming cellular material unit cells is triangular.

7. The reconfigurable acoustic metamaterial of claim 2, wherein the sound-attenuating structures are sound-attenuating rods.

8. The reconfigurable acoustic metamaterial of claim 7, wherein the sound-attenuating rods are arranged parallel to each other.

9. A reconfigurable noise barrier comprising:
a base formed of a two-dimensional phase-transforming cellular material; and
a plurality of sound-attenuating structures extending from one side of the base,
wherein phase transformation of the phase-transforming cellular material of the base in a first in-plane direction shifts the sound-attenuating structures from an expanded configuration to a contracted configuration, and wherein phase transformation of the phase-transforming cellular material of the base in a second in-plane direction shifts the sound-attenuating structures from the contracted configuration to the expanded configuration.

10. The reconfigurable noise barrier of claim 9, wherein the sound-attenuating structures are rods, and wherein the rods are aligned substantially parallel with each other.

11. The reconfigurable noise barrier of claim 10, wherein the rods are closer to each other in the contracted configuration than in the expanded configuration.

12. The reconfigurable noise barrier of claim 10, wherein the rods are arranged in a hexagonal configuration on the phase-transforming cellular material.

13. The reconfigurable noise barrier of claim 9, wherein the two-dimensional phase-transforming cellular material comprises a plurality of phase-transforming cellular material unit cell arranged in plane and interconnected to shift in-plane between a contracted configuration and an expanded configuration.

14. The reconfigurable noise barrier of claim 13, wherein the phase-transforming cellular material unit cells and the sound-attenuating structures are arranged in a plurality of phononic crystals, each phononic crystal formed of six of the phase-transforming cellular material unit cells connected together to form a hexagon with a sound-attenuating structure carried by each phase-transforming cellular material unit cell.

15. The reconfigurable noise barrier of claim 9, wherein the phononic crystals are aligned adjacent each other to form an elongate wall.

16. The reconfigurable noise barrier of claim 15, wherein the elongate wall is disposed adjacent a roadway and extends parallel to the roadway.

17. The reconfigurable noise barrier of claim 15, wherein the roadway is a controlled-access highway.

18. A method of using the reconfigurable noise barrier of claim 9, the method comprising:
contracting the two-dimensional phase-transforming cellular material of the base in plane with first in-plane forces to shift the sound-attenuating structures closer together toward the contracted configuration thereof; and
expanding the two-dimensional phase-transforming cellular material of the base in plane with second in-plane forces opposite the first in-plane forces to shift the sound-attenuating structures further apart toward the contracted configuration thereof.

19. The method of claim 18, wherein the method is performed while the phononic crystals are aligned adjacent each other to form an elongate wall adjacent a roadway.

20. The method of claim 19, further comprising dynamically expanding and contracting the two-dimensional phase-transforming cellular material of the base to adapt the acoustic properties of the reconfigurable noise barrier in real-time to varying traffic noise frequencies.
